(19) United States
(12) Patent Application Publication
(10) Pub. No.: US 2023/0046771 A1
(43) Pub. Date: Feb. 16, 2023

(54) AUTOMATED COLLABORATION ANALYTICS

(71) Applicant: MORGAN STANLEY SERVICES GROUP INC., New York, NY (US)

(72) Inventors: Sathish Kannan, Edison, NJ (US); Sujit Eapen, Plainsboro, NJ (US); Jwalin Pandya, West Windson Township, NJ (US); Dominic Ajagba, New York, NY (US); Xiaoran Liu, Seacaucus, NJ (US); Karan Kamanahalli Omprakash, Lyndhurst, NJ (US); Rushabh Mehta, Jersey City, NJ (US); Sravya Saladi, Manhasset, NY (US)

(73) Assignee: MORGAN STANLEY SERVICES GROUP INC., New York, NY (US)

(21) Appl. No.: 17/401,133

(22) Filed: Aug. 12, 2021

(51) Int. Cl. G06Q 10/10; G06Q 10/06

(52) U.S. Cl. CPC G06Q 10/103; G06Q 10/06393

(57) ABSTRACT

A computer-implemented method for improving intercommunication and software quality among a geographically distributed team is disclosed. The method comprises automatically determining a location of each member of the team; automatically obtaining one or more objective measures of contributions by each member of the team to a collaborative project; based at least in part on the automatically determined locations and automatically obtained objective measures, calculating for each member of the team a normalized collaboration score, and based on values of collaboration scores calculated for each member of the team, generating an electronic message for delivery to a computing device to cause the computing device to act in accordance with an instruction contained within the electronic message.

### FIELD OF INVENTION

This application relates to systems for and methods of automated analysis of received electronic documents, and more specifically, to systems that monitor uploads by software developers or other individuals to a repository and that track and respond to collaborative efforts by those individuals as they work on collective projects.

### BACKGROUND

As organizations grow, they tend to establish more complicated hierarchies and departments, to work on projects in increasing number and with narrower scope and specialization, and to establish offices in varied locations. In response to these natural effects of the organization's growth, there is a tendency that members, employees, or affiliates of the organization will establish a niche (or be assigned a niche) and rarely venture outside that niche in their work for the organization. Although this specialized division of labor is generally more efficient for an organization, it is possible that certain assumptions, habits, practices, mindsets, etc. may become entrenched in a particular department, office, or project, and that there would be a benefit to fresh thinking being injected by participation of new individuals, or cross-disciplinary work being enabled by improved collaboration and communication.

In order to promote collaboration, communication, and cross-disciplinary work, an organization may wish to incentivize and promote collaboration between individuals who would not normally communicate or collaborate, track when such collaboration begins occurring, track the quality of the collaboration and of the results of the collaboration, and reward the collaboration.

However, present systems for tracking or rewarding collaboration are generally limited to gathering information from secondary human participants, such as receiving a personnel review uploaded by a collaborator's manager that verifies the collaborator's work in a non-standardized and non-objective format that makes comparison among individuals more difficult, and makes automation of responses to the information more difficult as well.

Thus, there would be an advantage for any organization to have a system that could automatically review collaborative work, provide objective tracking and measurement of the collaboration to enable a positive response by an organization, and automatically implement the desired positive response.

### BRIEF SUMMARY OF THE INVENTION

A system for improving intercommunication and software quality among a geographically distributed team is disclosed. The system comprises one or more processors and non-transitory memory storing instructions. The instructions, when executed by the one or more processors, cause the one or more processors to automatically determine a location of each member of the team; automatically obtain one or more objective measures of contributions by each member of the team to a collaborative project; based at least in part on the automatically determined locations and automatically obtained objective measures, calculate for each member of the team a normalized collaboration score, and based on values of collaboration scores calculated for each member of the team, generate an electronic message for delivery to a computing device to cause the computing device to act in accordance with an instruction contained within the electronic message.

Similarly, a computer-implemented method for improving intercommunication and software quality among a geographically distributed team is disclosed. The method comprises, among other features, automatically determining a location of each member of the team; automatically obtaining one or more objective measures of contributions by each member of the team to a collaborative project; based at least in part on the automatically determined locations and automatically obtained objective measures, calculating for each member of the team a normalized collaboration score, and based on values of collaboration scores calculated for each member of the team, generating an electronic message for delivery to a computing device to cause the computing device to act in accordance with an instruction contained within the electronic message.

### BRIEF DESCRIPTION OF THE DRAWINGS

Other aspects, features and advantages will become more fully apparent from the following detailed description, the appended claims, and the accompanying drawings (provided solely for purposes of illustration without restricting the scope of any embodiment), of which:

FIG. 1 depicts a network of computing devices to be used in a system for improving intercommunication and software quality among a geographically distributed team;

FIG. 2 depicts an exemplary configuration of devices and software modules in communication to facilitate the intercommunication and improvement of software quality;

FIG. 3 depicts, in simplified form, a method of automatically obtaining collaboration data from members of a team for analysis;

FIG. 4 depicts sample generated scorings for members of a hypothetical team according to embodiments described herein;

FIG. 5 depicts a sample user interface for display of and facilitating action based upon calculated collaboration scores; and

FIG. 6 is a high-level block diagram of a representative computing device that may be utilized to implement various features and processes described herein.

### DETAILED DESCRIPTION

In order to address the issues described further above with respect to prior systems, a system is provided to enable automatic collection of data from a variety of sources concerning a collaborator's projects and contributions, and to both provide useful derived data about the collaboration to other members of the organization and have the organization's automated systems act on that data within particular contexts.

In contrast to previous systems, the presently-described system is capable of interacting with a variety of application programming interfaces (APIs) of systems internal to the organization and of external services used by the organization to gather information, and process it to form objective assessments that can be used in the future, without the need to consult human evaluators of the collaboration, or the drawbacks of relying on human-generated information.

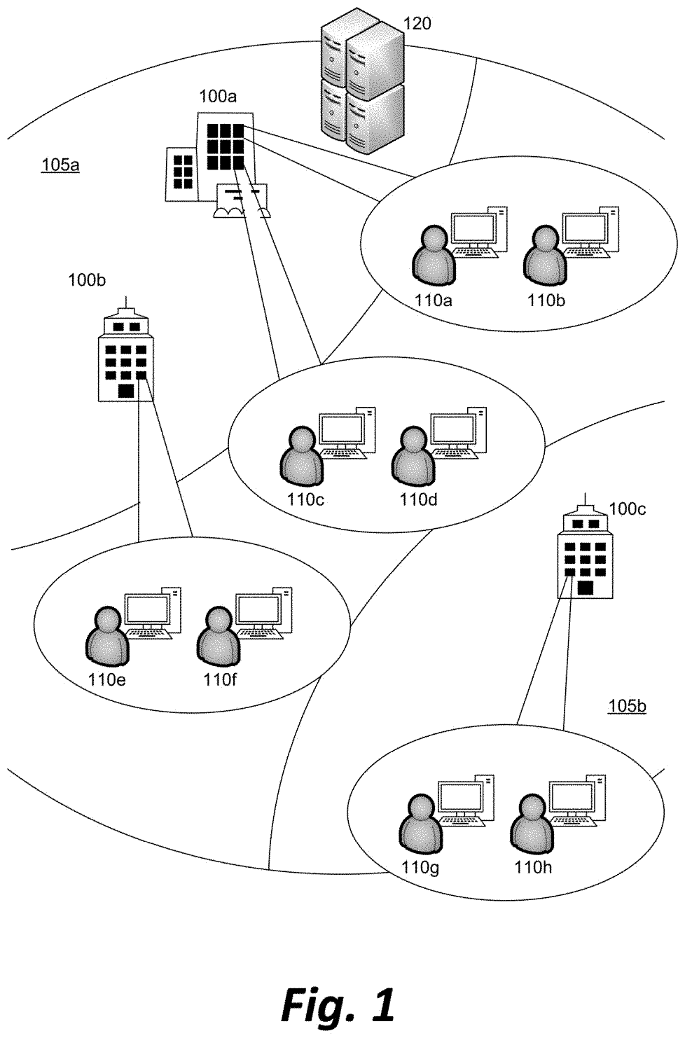

FIG. 1 depicts a network of computing devices to be used in a system for improving intercommunication and software quality among a geographically distributed team.

An example organization, that could benefit from encouraging collaboration might have three offices 100a-100c spread across two continents 105a and 105b, with a number of software developers 110a-110h working in the various offices 100a-100c. Each software developer 110 operates a personal computer 115 to download communications and files from a central server cluster 120; to write code, generate additional documents, or create communications for receipt by other software developers; and to transmit any code, documents, or communications back to the central server cluster 120 for distribution or making available to the other software developers of the organization.

In the illustrated example, developer 110a works on the same floor of office 100a with developer 110b. They work in a same business unit or other subdivision of the organization, working on projects with a common theme and supervisor. For example, developers 110a and 110b might both work on writing software that automates the routing of messages through a network of routers to achieve ultra-low latency transmission of time-critical messages.

Additional developers 110c and 110d work on a different floor of the same office 100a. Although they share the same location, they are assigned to a different business unit from that of developers 110a and 110b, have a different supervisor, and may work on projects for a completely different aspect of the organization's products. For example, developers 110c and 110d might work on systems for automatically reviewing written source code to search for possible software vulnerabilities, and for automatically determining an objective measure of how ready code is for final publication. Although they would be unlikely to work directly on a collaborative project with developers 100a and 100b under normal circumstances, due to the very different niche fields of expertise, the software each group writes would at least interact with the other's, and each might have valuable insights to share with the other. Networking developers might have advice for updating automated code review to reduce false positives in detected errors, while code analysis developers might have advice for approving the efficiency of code written for the routing system.

Two more developers 110e and 110f work in a separate office 100b of the organization on the same continent 105a. Naturally, they are likely to have a different supervisor from any of the other developers (although, with the increasing use of telework and distributed teams, this is by no means a certainty), and they may or may not be part of yet another business unit or department of the organization.

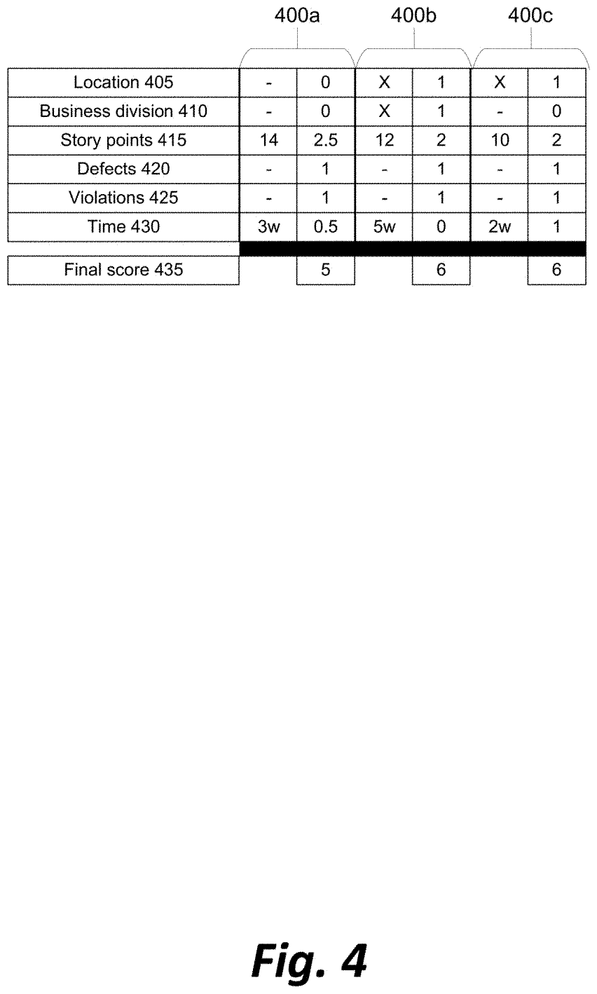

Two more developers 110g and 110h work in a third office 100c on a second continent 105b. They are even more remote from all the previously mentioned developers than any of those developers were from each other, and may or may not be part of yet another business unit or department of the organization. In an example described further below in FIG. 4, one developer 110g is part of the same business unit as the developers 110a and 110b, while the other developer 110h is not.

When code is uploaded to the central server cluster 120, a number of external services 210, described further below, may be provided access to the code for various analysis and execution tasks. Other external services 210 may track when developers 110 are contributing to various software projects within the corporation and when they solve software issues or complete features.

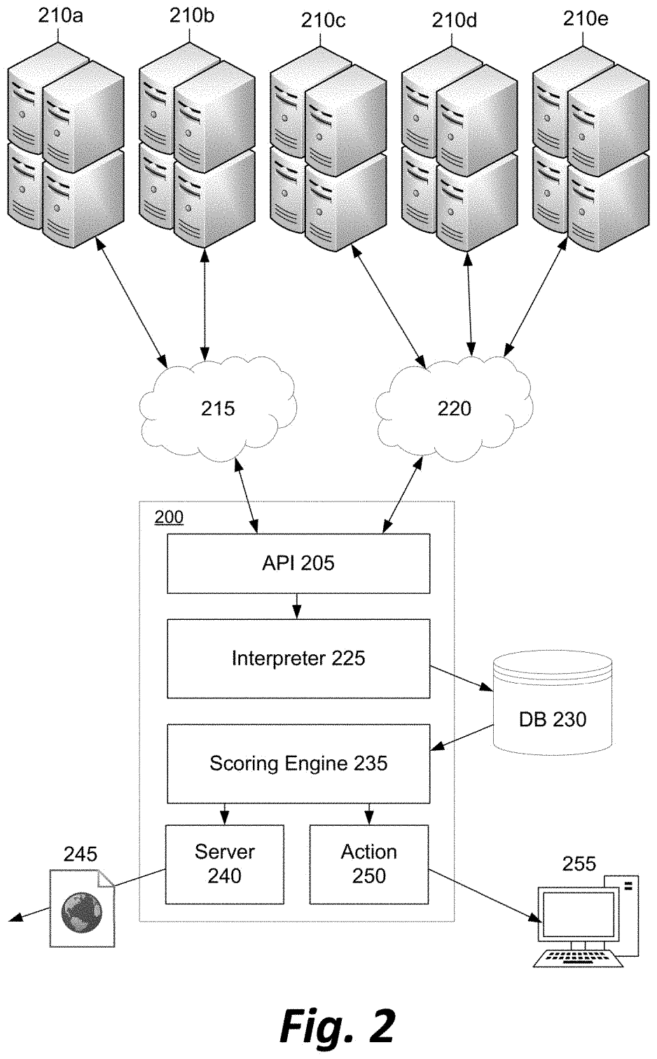

FIG. 2 depicts an exemplary configuration of devices and software modules in communication to facilitate the intercommunication and improvement of software quality.

In a preferred embodiment, a data retrieval application programming interface (API) 205 is used to draw data from five separate data sources 210a-210e. The data retrieval API 205 may be hosted on a particular computing device 200 in the central server cluster 120. In other embodiments, the computing device 200 may he remote from the central server cluster 120—for example, if the organization uses multiple computing clusters for receiving and publishing code, and only needs one of them to actually host the project for analyzing collaboration—and use the API 205 to communicate with computers in the cluster 120.

In virtually any embodiment, the data retrieval API 205 will download data from a user profile database 210a. The user profile database stores the basic information about a human participant necessary to determine that a collaboration is actually occurring across departments, offices, disciplines, or other divisions, and link that collaboration to the human participant. For example, the user profile database may store each participant's name, department, office location, assigned teams, assigned projects, usernames used in various computing systems, other identifiers by which the participant may be known in other contexts, and other information related to the participant's work with the organization. In some embodiments, rather than location being an immutable attribute of the participant's employment, location may be updated based on a current location of the participant, as determined by a GPS or other location determining device in a computing device used by the participant, or as determined by an IP address or network to which the participant connects during collaboration.

In some embodiments the data retrieval API 205 will also download data from a feedback database 210b. The feedback database may store various information generated by other users directly regarding a human participant or indirectly regarding the participant by concerning work product of the human participant or projects on which the human participant worked. This information may include performance evaluations, code reviews, past disciplinary actions, or any other form of evaluation of an individual and his or her work.

In most embodiments, the user profile and feedback databases 210a and 210b would be stored locally with respect to the computing device 200 and would be accessed by an intranet 215 administered by the organization. In other embodiments, the user profile and feedback databases 210a and 210b could be located remotely with respect to the computing device 200, or cloud storage could be used to store this information in a location remote to and unknown by the computing device 200, with the Internet 220 more generally being used to access information from those data sources.

In some embodiments, the data retrieval API 205 will also download data from a Jira database 210c or other service for tracking software project issues and completion of software project sub-tasks. For example, the API 205 may obtain a set of support tickets, tasks, and/or story points associated with a software project, as well as which developer is assigned the ticket/task/point, or which developer has already addressed the ticket/task/point. The API is able to link software issues that have been experienced in production with a particular developer who introduced the issue or has not yet fixed the issue.

In some embodiments, the data retrieval API 205 will also download data from a TeamCity database 210d or other service for build management and continuous integration. For example, the TeamCity database may provide information to the API 205 concerning the current ability of software in a project to be compiled and run, including numbers of compile-time errors, compile-time warnings, and any missing software dependencies or existing code that is no longer used by the project.

In some embodiments, the data retrieval API 205 will also download data from a SonarCloud database 210e or other service for automated analysis of code quality. Services like SonarCloud may provide real time tinting (i.e., static code analysis) of code checked in by various developers and may provide counts of software errors, identification of anti-patterns and software “smells” (i.e., sections of code that are structured in such a way as to indicate a poor design lacking robustness), identification of potential vulnerabilities, lack of unit test coverage, or other indicators within source code itself that indicate a potential problem unforeseen by a developer could occur at runtime.

In most embodiments, the Internet 220 would he used to access the cloud-based data sources 210c, 210d, and 210e. However, since these services could have a “roll your own” local implementation, or be replaced by software developed by the organization to provide similar functionality, there is no reason why external Internet access would intrinsically be needed, and that the API 205 might not connect to these data sources 210c 210d, and 210e via a local intranet 215 administered by the organization.

In other embodiments, additional data sources may be consulted to the extent that they provide any additional information regarding an individual participant, that participant's communications with others, that participant's work product shared with others, or any other way in the participant might affect other members of the organization or the organization's projects more broadly.

When raw data is received from each of the data sources 210a-210e, a scoring interpreter 225 is used to perform any necessary parsing, redacting, or other data conversion to make the raw data usable by other elements of the system. For example, if a response received by the API 205 is in an XML format and only a particular value is actually needed, the scoring interpreter may strip out unnecessary XML tags and pass on only the required value. If the response includes a JavaScript Object Notation (JSON) object or other object having a variety of attributes and values of those attributes, the scoring interpreter may store whatever logic is necessary to traverse the object and extract those data values that are relevant.

One or more scoring databases 230 store information gathered by the scoring interpreter 225 until all data has been gathered and is ready for incorporation into a total overall assessment of collaboration for each of the developers or other participants 110a-110h.

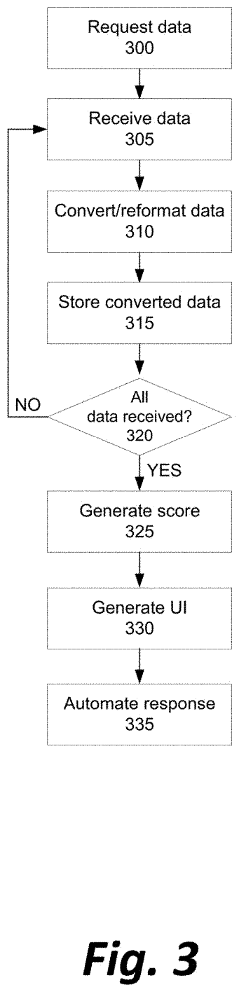

A scoring engine 235 software module retrieves data concerning collaboration from the scoring database 230 and converts it into a more concise metric—ideally in the form of a numerical rating, such as a value from 0 to 10, though conceivably being expressed in a variety of alternative formats—according to a method described further below in relation to FIG. 3 and example output of which is described further below in relation to FIG. 4.

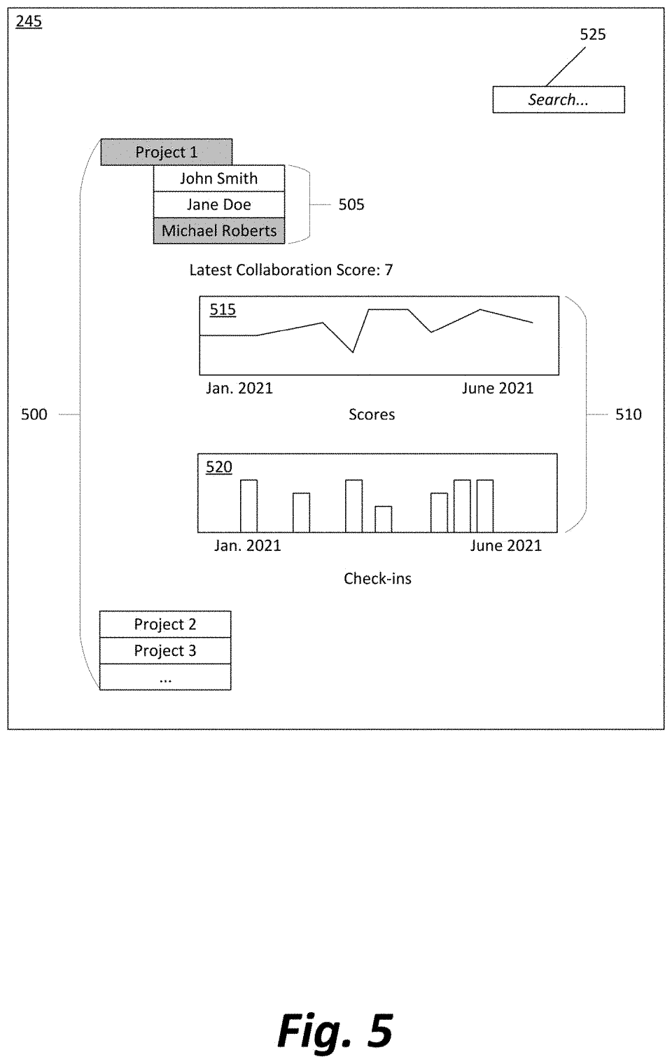

A server 240 may be used to generate and serve in response to client requests a webpage or other user interface (UI) 245 to display information concerning the metrics determined by the scoring engine 235. In a preferred embodiment, the UI 245 is interactive and allows functionality described in greater detail below in relation to FIG. 5. An interactive UI 245 may be provided in the form of a hypertext markup language (HTML) webpage with client-side scripting to update the in response to the user selecting a particular individual, department, project, or other attribute in order to “drill down” and see more information related to the selected individual or entity. Alternative interactive UIs may be provided in the form of an HTML webpage that is static but has hyperlinks to additional static pages generated server-side in response to user queries; a mobile app for displaying generated data; an executable desktop application for displaying generated data; a potentially interactive document format such as a portable document format (PDF) or Excel document having scripts or macros to provide interactive functionality; or any other means of updating the display of a computing device to display more specific information to a user compared to a default data presentation, in response to the user's request to drill down. In other embodiments, information may be presented in the form of a non-interactive UI 245. Non-interactive UIs may include, for example, written reports in Word, Excel, PDF, extensible markup language (XML), or other static document formats without macros or scripting; a static HTML wen page that displays similar information in a browser window; in an email, text, instant message, or other communications protocol delivering static messages; in a document sent to a printer for automatic printing and archiving in paper format; or in any other static form for the presentation of data to a human user.

The server 240 may store any generated UIs 245 until requested for download by a human user, or may preemptively push an updated UI to some other computing device that a human user expects to use to access the UI 245. The server 240 may also work in conjunction with a credentialing server or other manager of permissions to determine which users have full access to view data concerning collaboration scores and, for other users, to provide only selectively redacted data or to prevent access to the data entirely.

In some embodiments, an action module 250 may further act upon the output from the scoring engine. The action module 250 may be connected to one or more computing devices 255 by a software API, by some sort of messaging queue that can process requests from the action module 250, or by a data bus that transmits signals via a wired connection to said computing devices. Examples of actions the action module 250 might undertake may be found in discussion further below of Step 335 in FIG. 3.

Although a particular division of functions between devices is described in the system above, other configurations are possible in which functions are divided among devices differently. For example, all of the functions of the databases 210a-210e, computing device 200, and cluster 120 may be performed by a single device with multiple threads executing different software modules simultaneously. Similarly, devices might be grouped by functionality, such that databases 210a-210e are all databases stored by a single database server which is inaccessible to users, and the computing device 200 and its various modules are in a single server that is accessible to users and acts as the interface for obtaining; inserting, or manipulating data from the database. Alternatively, each system ear device may in fact be a cluster of computing devices sharing functionality for concurrent processing. The specific number of computing devices and whether communication between them is network transmission between separate computing devices or accessing a local memory of a single computing device is not so important as the functionality that each part has in the overall scheme.

Further, although various computing elements 120, 200, and 210a-210e are described as if they are one computing device or cluster each, a cloud-based solution with multiple access points to similar systems that synchronize their data and are all available as backups to one another is preferable to a unique set of computing devices all stored at one location.

As is suggested by the functionality and arrangement of modules in FIG. 2, a streamlined method is routinely to be used to automatically obtain collaboration data from members of a team for analysis. FIG. 3 depicts this method in simplified form.

First, the API 205 is used to request data from one or more external resources 210 (Step 300). The request(s) for data may be asynchronously made in parallel, or alternatively may be made sequentially if there are limits on networking bandwidth or computing power that for some reason make asynchronous requests less preferable.

Next, the API waits until all responses are received to the request(s) (Step 305). If no response is received within a predetermined window of time, the request(s) may be re-sent in case a network disruption or error at the recipient caused the request or its response not to be fully transmitted.

Once received, the response(s) to the request(s) are passed to the scoring interpreter for conversion or reformatting of data (Step 310) to the extent necessary for storage in the one or more databases 230 (Step 315).

If all necessary data has not yet been received and processed (Step 320), for example, if the requests were sequential instead of asynchronous, the process returns to step 300 and selects a different external resource to query.

If all necessary data has been received, the scoring engine 235 generates a score (Step 325) based on weighting the collected input data.

In a preferred embodiment tracking the collaboration by software developers working on a shared project, each developer associated with the shared project is assigned a numeric score between 0 and 10 according to the following metrics:
If the developer is based in a different location from the project, the developer is awarded one point; if in the same location, no point is awarded. Depending on the embodiment, “location” may be defined at varying levels of stringency, ranging from “in the same building” to “on the same continent,” depending on what kind of collaborative work the organization wants to encourage. In some organizations, international collaboration and diversity may be specifically desired, while in others, perhaps collaboration between workers at different locations in a same city would be just as valuable to the organization. In some embodiments, partial points may be awarded for differing levels of remote cooperation, such as a full point for international collaboration, half a point for collaboration from a different region of a same country, and a quarter point for collaboration from a different location in a same city.
If the developer is a member of a different business unit, division, or department of an organization from the one managing the project, the developer is awarded one point; if from the same entity, no point is awarded. Similar to the “location” attribute, an organization may set different point values for differing intra-organizational relationships, the structures of which will naturally be unique to that organization.
The proportion of unit test coverage of the developer's is determined by SonarCloud's linter or other analysis gleaned by the data source 210e, with two points being awarded for 100% coverage, one point being awarded for incomplete coverage greater than or equal to 75%, and no point being awarded if coverage is less than 75%. Organizations may wish to modify these values and cutoffs depending on the desired incentives to quality or risk tolerances.
Compliance with one or more coding standards may be determined by the same linter or other analysis gleaned by the data source 210e. If all expected standards are met and the code lacks any detected anti-patterns or policy violations, the developer is awarded a point; otherwise, no point is awarded.
The same linter/data source 210e provides information on software defects or vulnerabilities that are present in the code, and TeamCity or the other build management service 210d provides information concerning whether the project can currently build successfully, or if instead there is a compiling error, missing dependency, or other issue that prevents the project from successfully building. If there are no detected defects and the project builds successfully, the developer is awarded a point; otherwise, no point or possibly half a point may be awarded, depending on the number and nature of detected defects.
Jira or the other task tracking data source 210c provides information regarding the number of task story points that have been completed by the developer, and the number is scaled down to a predetermined range of possible points to award. For example, 21 or more story points could correspond to 3 points awarded, 15-20 story points to 2.5 points awarded, 8-14 story points to 2 points awarded, 5-7 story points to 1.5 points awarded, 3-4 story points to 1 point awarded, and 1-2 story points to half a point awarded.
Finally, the timestamp(s) of the developer's contribution(s) are compared to when the developer was first added to the project. If the developer helped to deliver a code check-in with improved features within two weeks of joining, the developer is awarded a bonus point, and if the developer delivered code within a month, the developer is awarded a half point.
In some embodiments, additional feedback data generated by the developer's manager, a manager of the collaborative project, or other members of the team and retrieved from the data source 210b may be used to adjust the score upward or downward based on subjective factors that are not fully captured by the objective automated systems such as Jira, TeamCity, and SonarCloud.

As a result of the above-described scoring system, an optimal contribution (cross-location and -business unit, extensive, prompt, and error free) could receive a score of 10 points, with a somewhat lower score being more typical. Examples of applying this scoring system can be found further below in the description of FIG. 4. In other embodiments, similar numerical ratings with finer scales may be used, such as systems that generate a score between 0 and 100 or 0 and 1000. In some embodiments, a more differentiable scale may be achieved by a scale with no specific maximum rating and that permit developers to pursue a “high score” that is limited only by a developer's willingness to perform actions that are associated with an increase in score. For example, if a collaboration score were to increase by ono point for every check-in of new code, developers would be incentivized to collaborate to a greater extent than if they received a score for their first check-in with no changes after subsequent check-ins.

In still other embodiments, non-numerical scores might be generated, or allocated based on a previously generated numerical score. For example, developers might receive a letter grade from “A” to “F” based on their numerical collaboration score (“A” representing a collaboration score of 9-10 out of 10, “B” representing a collaboration score of 8-9 out of 10, etc.), or might receive a color designation (along a spectrum of blue, green, yellow, orange, red, etc.) visually indicating a level of collaboration with others and similarly derived from a corresponding range of numerical values.

After the score is generated, a UI is also generated by the server 240 to display the score and information associated with it (Step 330), which is described further below in relation to FIG. 5.

In some embodiments, an additional final step involving automated action (Step 335) is performed. While collaboration data is most naturally useful to inform a human manager of a participant that the collaboration occurred and to assist the manager in making future personnel and management decisions, there may be additional technical effects that are desirable to immediately accomplish without human involvement and without waiting for a human to review output of the scoring system.

For example, positive collaboration on a particular project may lead to elevated privileges for a particular user. A user could have credentials updated to allow access to or modification of files that would normally be locked for another user without as high a collaboration score. This could be accomplished by the action module 250 tying into a filesystem or credentialing system to automatically associate the user as privileged with respect to one or more files.

In systems where the decision whether to publish software is based on a scoring system or other fuzzy logic applied to the code under consideration, the collaboration score of the code's author could be considered as a factor in the decision, such that a higher collaboration score could cause software authored to be automatically promoted from a development environment to a production environment without requiring further human review.

After determination of a collaboration score, the system could trigger automatic download of files relevant to the collaboration to a participant's computing device, such as files created by other participants in the collaboration.

In an environment with limited resources, such as a poor network connection between two nodes in the organization's intranet, participants with higher collaboration scores could be automatically prioritized during the routing of network traffic, in comparison to traffic associated with others who generally do not collaborate or have lower-quality contributions to collaborative projects.

After determination of a collaboration score, the participant could be automatically added to a group email list or another interactive communication channel with other participants, to which the participant would not normally be invited or have access.

Other automated actions could be directed to human users, but not involve generation of or updates to the UI 245. For example, an email could be automatically generated and sent to other participants in the project to notify them of the participant's collaboration and invite them to congratulate the participant and continue communicating with him or her. Similarly, text messages (SMS), instant messages, mobile computing device notifications, and other means of notifying a human user of a participant's collaboration may be generated.

FIG. 4 depicts sample generated scorings for members of a hypothetical team according to an embodiment described herein, in Step 325 of FIG. 3.

Referring back to FIG. 1, a particular project might be handled by a department based in office 100a with participation by developers 110a, 110c. and 110g, who each receive scores 400a, 400b, and 400c, respectively, determined by the scoring engine 235.

Since the first developer 110a is located in the same office as the project is based, he receives no points as a location score 405. In contrast, the other two developers 110c and 110g are based in different offices and receive one point each.

Since the first developer 100a is also assigned to the project as normally being part of his business unit, he receives no points for a business division score 410, either. Developer 110c is from a different business unit, and accordingly receives a point for his division score. Developer 110g, is a member of the same business unit despite being remote from the Alice 100a, and does not receive a point on that basis.

Developer 110a completes 14 story points 415 by adding new features and recording those additions in Jira's records of the project. In contrast, developer 110e completes 12 story points and developer 110g completes 10 story points. As a result, developer 110a receives 2.5 points and developers 110c and 110g each receive 2 points.

All three developers submit code without defects 420 or policy violations 425 and thereby earn two points.

Developer 110a checks in his code after three weeks 430, while developer 110c checks in code after five weeks and developer 110g checks in code after two weeks. As a result, they receive half a point, no point, and one point, respectively.

As a result of these sub-calculations, the developers 110 receive final scores 435 of 5, 6, and 6, respectively.

FIG. 5 depicts a sample user interface for display of and facilitating action based upon calculated collaboration scores.

An interactive user interface 245 might be organized to display a series of projects 500, such that clicking, tapping, or otherwise interacting with any project name causes the participants 505 associated with that project to be displayed. Associated with each participant may be any number of statistics related to collaboration scores, such as the last collaboration score calculated, the average of all collaboration scores calculated, the median of all collaboration scores calculated, an average of past collaboration scores weighted by recency to favor more recent scores, or a sum total of all collaboration scores calculated for the participant.

Selecting a participant may cause various graphs or tables 510 to be displayed with data concerning the participant. Examples may include a graph 515 showing collaboration scores over a window of time, a timeline 520 showing past code check-ins or other contributions to the project by the participant, a comparison showing how the participant's collaboration scores compare to other members of the project, or a list of past software issues obtained from Jira or the similar data source 210c and solved by or introduced by the participant's contributions.

Various visual indicators may be included throughout the interactive user interface 245 to dray attention to or give context to data. For example, collaboration scores may be rendered in a font color that changes based on the value of the score in an absolute sense, or compared to other members of a team or generally. Projects may similarly be displayed with particular colors or other font effects to indicate a particularly high or low level of collaboration occurring Within that project.

A search bar 525 may also be used to quickly filter out information unrelated to a particular project or participant of interest entered by a user into the search bar.

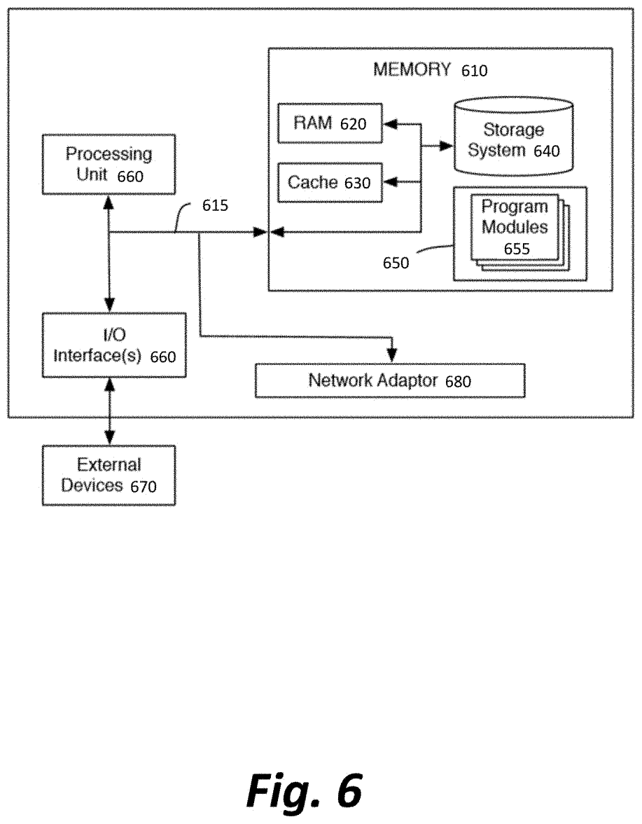

Although FIGS. 1 and 2 depict a preferred configuration of computing devices and software modules to accomplish the software-implemented methods described above, those methods do not inherently rely on the use of any particular specialized computing devices, as opposed to standard desktop computers and/or web servers. For the purpose of illustrating possible such computing devices, FIG. 6 is a high-level block diagram of a representative computing device that may be utilized for each of the computing devices and/or systems to implement various features and processes described herein. The computing device may be described in the general context of computer system-executable instructions, such as program modules, being executed by a computer system. Generally, program modules may include routines, programs, objects, components, logic, data structures, and so on that perform particular tasks or implement particular abstract data types.

As shown in FIG. 6, the components of the computing device may include (but are not limited to) one or more processors or processing units 600, a system memory 610, and a bus 615 that couples various system components including memory 610 to processor 600.

Bus 615 represents ono or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Processing unit(s) 600 may execute computer programs stored in memory 610. Any suitable programming language can be used to implement the routines of particular embodiments including C, C++, Java, assembly language, etc. Different programming techniques can be employed such as procedural or object oriented. The routines can execute on a single computing device or multiple computing devices. Further, multiple processors 600 may be used.

The computing device typically includes a variety of computer system readable media. Such media may be any available media that is accessible by the computing device, and it includes both volatile and non-volatile media, removable and non-removable media.

System memory 610 can include computer system readable media in the form of volatile memory, such as random access memory (RAM) 620 and/or cache memory 630. The computing device may further include other removable/non-removable, volatile/non-volatile computer system storage media. By way of example only, storage system 640 can be provided for reading from and writing to a non-removable, non-volatile magnetic media (not shown and typically referred to as a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 615 by one or more data media interfaces. As will be further depicted and described below, memory 610 may include at least one program product having a set (e.g., at least one) of program modules that are configured to carry out the functions of embodiments described in this disclosure.

Program/utility 650, having a set (at least one) of program modules 655, may he stored in memory 610 by way of example, and not limitation, as well as an operating system, one or more application software, other program modules, and program data. Each of the operating system, one or more application programs, other program modules, and program data or some combination thereof, may include an implementation of a networking environment.

The computing device may also communicate with one or more external devices 670 such as a keyboard, a pointing device, a display, etc.; one or more devices that enable a user to interact with the computing device; and/or any devices (e.g., network card, modem, etc.) that enable the computing device to communicate with one or more other computing devices. Such communication can occur via Input/Output (I/O) interface(s) 660.

In addition, as described above, the computing device can communicate with one or more networks, such as a local area network (LAN), a general wide area network (WAN) and/or a public network (e.g., the Internet) via network adaptor 680. As depicted, network adaptor 680 communicates with other components of the computing device via bus 615. It should be understood that although not shown, other hardware and/or software components could be used in conjunction with the computing device. Examples include (but are not limited to) microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may use copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may he provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system for improving intercommunication and software quality among a geographically distributed team, comprising:
one or more processors; and
non-transitory memory storing instructions that, when executed by the one or more processors, cause the one or more processors to:
automatically determine a location of each member of the team;
automatically obtain one or more objective measures of contributions by each member of the team to a collaborative project;
based at least in part on the automatically determined locations and automatically obtained objective measures, calculate for each member of the team a normalized collaboration score; and
based on values of collaboration scores calculated for each member of the team, generate an electronic message for delivery to a computing device to cause automatic promotion of software written by a member of the team from a development environment to a production environment based on that member's collaboration score being higher than a predetermined threshold.

2. The system of claim 1, wherein the one or more objective measures of contributions comprise a count of story points from a task- or issue-tracking system that have been implemented by code checked in by a team member.

3. The system of claim 1, wherein the one or more objective measures of contributions comprise a proportion of unit test coverage of code checked in by a team member.

4. The system of claim 1, wherein the one or more objective measures of contributions comprise a number of automatically identified defects in code checked in by a team member.

5. The system of claim 1, wherein the one or more objective measures of contributions comprise a number of automatically identified software anti-patterns in code checked in by a team member.

6. The system of claim 1, wherein the one or more objective measures of contributions comprise a length of time taken to write code checked in by a team member.

7. (canceled)

8. The system of claim 1, wherein the electronic message further causes a notification to be displayed to a human user who manages at least one member of the team.

9. The system of claim 1, wherein the electronic message further causes an update of a graphical user interface to display at least one collaboration score of at least one member of the team.

10. The system of claim 9, wherein the graphical user interface is interactive and enables the comparison of collaboration scores of multiple team members who worked on a project selected by a human user of the graphical user interface.

11. A computer-implemented method of improving intercommunication and software quality among a geographically distributed team, comprising:
automatically determining a location of each member of the team;
automatically obtaining one or more objective measures of contributions by each member of the team to a collaborative project;
based at least in part on the automatically determined locations and automatically obtained objective measures, calculating for each member of the team a normalized collaboration score; and
based on values of collaboration scores calculated for each member of the team, generating an electronic message for delivery to a computing device to cause the computing device to act in accordance with an instruction contained within the electronic message.

12. The method of claim 11, wherein the one or more objective measures of contributions comprise a count of story points from a task- or issue-tracking system that have been implemented by code checked in by a team member.

13. The method of claim 11, wherein the one or more objective measures of contributions comprise a proportion of unit test coverage of code checked in by a team member.

14. The method of claim 11, wherein the one or more objective measures of contributions comprise a number of automatically identified defects in code checked in by a team member.

15. The method of claim 11, wherein the one or more objective measures of contributions comprise a number of automatically identified software anti-patterns in code checked in by a team member.

16. The method of claim 11, wherein the one or more objective measures of contributions comprise a length of time taken to write code checked in by a team member.

17. (canceled)

18. The method of claim 11, wherein the electronic message further causes a notification to be displayed to a human user who manages at least one member of the team.

19. The method of claim 11, wherein the electronic message further causes an update of a graphical user interface to display at least one collaboration score of at least one member of the team.

20. The method of claim 19, wherein the graphical user interface is interactive and enables the comparison of collaboration scores of multiple team members who worked on a project selected by a human user of the graphical user interface.

21. The system of claim 1, wherein the electronic message further causes a filesystem to automatically update privileges to modify a file for a member of the team, based at least in part on a calculated collaboration score for that member of the team.

22. The method of claim 11, wherein the electronic message further causes a filesystem to automatically update privileges to modify a file for a member of the team, based at least in part on a calculated collaboration score for that member of the team.
